(19) United States
(12) Patent Application Publication
(10) Pub. No.: US 2018/0254129 A1
(43) Pub. Date: Sep. 6, 2018

(54) Temperature Sensor Element

(71) Applicant: KOA Corporation, Ina-shi (JP)

(72) Inventor: Ryusuke SUZUKI, Fuchu-shi (JP)

(21) Appl. No.: 15/913,226

(22) Filed: Mar. 6, 2018

(30) Foreign Application Priority Data
Mar. 6, 2017 (JP) 2017-042073

(51) Int. Cl. H01C 7/00; H01C 1/01; H01C 1/14; H01C 1/142; H01C 17/065; G01K 7/18

(52) U.S. Cl. CPC H01C 7/003; H01C 1/01; G01K 7/18; H01C 1/142; H01C 17/065; H01C 1/14

(57) ABSTRACT

A resistance pattern and a pair of internal electrodes are formed on a main face of a cuboidal insulating substrate. The pair of internal electrodes are connected to opposite end portions of the resistance pattern. A surface glass film is formed to cover the entire main face including a pair of lead wires and a protective film. The pair of lead wires are bonded to the internal electrodes and protrude outward from the insulating substrate. The protective film is formed on the resistance pattern. The surface glass film extends over a region covering respective upper-side faces of the insulating substrate adjacent to the main face. The total dimension (T+D) is (T+D)≈W. T: a thickness of the insulating substrate, D: a wire diameter of each of the lead wires, W: a width of the insulating substrate along a lateral direction.

### BACKGROUND OF THE INVENTION

### 1. Field of the Invention

The present invention relates to a temperature sensor element which is, for example, used for an airflow sensor measuring an intake air quantity passing through an intake pipe. Particularly, it relates to a flat plate type temperature sensor element in which a resistance pattern containing platinum as a main component is formed on a cuboidal insulating substrate.

### 2. Description of the Background Art

In an internal-combustion engine such as a gasoline engine, an intake air quantity (intake quantity) is measured by an airflow sensor provided inside an intake pipe, and the measured intake air quantity is sent as an electric signal to an engine control unit (ECU) which thereby performs control to inject fuel in accordance with the air quantity taken into the engine.

There are several detection methods used in the airflow sensor. Among them, a method called a hot wire type (heating wire type) having a structure in which a platinum element (platinum heating wire) is disposed inside an intake pipe has been used broadly. Such a hot wire type airflow sensor uses the following configuration. That is, a current is made to flow through the platinum heating wire to increase its temperature due to self-heating. When air hits on a heating part of the platinum heating wire to thereby deprive the heat, resistance of the platinum heating wire changes. With this configuration, the hot wire type airflow sensor can detect an amount of the current flowing through the platinum heating wire to thereby measure an air quantity passing through the intake pipe.

In addition, when airflow sensors are roughly classified based on their structures, two types, i.e. a winding type element and a flat plate type element have been known. As described in JP-A-3-268302, the following element has been proposed as the winding type element. That is, in the element, lead wires are fixed to opposite end portions of a circularly cylindrical ceramic pipe. A platinum wire serving as a resistor is wound around an outer circumferential surface of the ceramic pipe. End portions of the platinum wire are connected to the lead wires.

On the other hand, as described in JP-A-11-121207, the following element has been proposed as the flat plate type element. That is, in the element, a resistance pattern made of a platinum film is formed on a cuboidal alumina substrate. A pair of terminal mounting electrodes are formed to be connected to opposite ends of the resistance pattern. Lead wires are bonded to the terminal mounting electrodes respectively and led to the outside. The resistance pattern is covered with a protective film.

Since the aforementioned winding type sensor element shows external appearance of a circular cylinder, a projected area of the sensor element does not change due to an installation angle when the sensor element is exposed to an airflow. Therefore, it is possible to suppress a detection result from varying due to disturbance of the airflow. However, it is difficult to make a winding pitch of the platinum wire stable. Such winding disorder directly links to a variation in resistance value. Therefore, there is a manufacturing problem that it is difficult to make the quality stable.

On the other hand, in the aforementioned flat plate type sensor element, the resistance pattern can be formed with high accuracy by photolithography. Accordingly, it is possible to easily manufacture a product which has no variation in resistance value. However, the flat plate type sensor element shows external appearance of a rectangular cylinder, and the sectional shape of the flat plate type sensor element is rectangular. Therefore, a projected area of the sensor element changes largely due to an installation angle when the sensor element is exposed to an airflow. Disturbance of the airflow is large around the element according to an installation state. There is hence a problem that a variation in temperature detection result is generated easily.

### SUMMARY OF THE INVENTION

The present invention has been accomplished in consideration of such actual circumstances inherent in the background art. An object of the present invention is to provide a temperature sensor element which can suppress temperature detection from varying due to an attachment angle etc.

In order to achieve the foregoing object, the present invention provides a temperature sensor element including: a cuboidal insulating substrate; a resistance pattern which contains platinum as a main component and which is formed on a main face of the insulating substrate; a pair of internal electrodes which are connected to opposite end portions of the resistance pattern; lead wires which are bonded to the pair of internal electrodes respectively and protrude outward from longitudinally opposite end portions of the insulating substrate; a protective film which covers the resistance pattern; and a surface glass film which covers the entire main face of the insulating substrate including the lead wires; wherein: the surface glass film is formed to cover at least respective upper-side faces of the insulating substrate adjacent to the main face, and when a width of the insulating substrate along a lateral direction, a thickness of the insulating substrate, and a wire diameter of each of the lead wires are designated by W, T and D respectively, W, T and D are set to satisfy a relation (T+D)≈W.

In the temperature sensor element configured thus, the resistance pattern formed on the main face of the insulating substrate is covered with the protective film. The surface glass film covering the entire main face of the insulating substrate including the protective film and the lead wires covers at least the respective upper-side faces of the insulating substrate adjacent to the main face. Accordingly, although the temperature sensor element is a flat plate type sensor element in which the resistance pattern is formed on the main face of the cuboidal insulating substrate, the surface glass film covering the main face of the insulating substrate is formed into a rounded shape in section with no edge portion. Moreover, the total dimension (T+D) of the thickness T of the insulating substrate and the wire diameter D of each of the lead wires is set to be substantially equal to the width W of the insulating substrate along the lateral direction, and a thickness-to-width ratio of the sensor element as a whole is substantially 1:1. Accordingly, even if an installation angle changes when the sensor element is exposed to an airflow, disturbance is hardly generated in the airflow hitting on the sensor element so that a detection result of the sensor element can be suppressed from varying due to the disturbance of the airflow.

In the temperature sensor element having the aforementioned configuration, when a length of the insulating substrate along the longitudinal direction is designated by L, each of the lead wires may be bonded to a corresponding one of the internal electrodes to occupy at least ⅙ of the length L. In this case, a ratio of bonding regions of the pair of lead wires to the entire length L of the insulating substrate in the longitudinal direction is at least 1/3, and the surface glass film is easily formed into a rounded shape in section all over the insulating substrate in the longitudinal direction.

In addition, in the temperature sensor element having the aforementioned configuration, the surface glass film may cover all faces of the insulating substrate including a back face opposite to the main face. In this case, the surface glass film can be formed into a rounded shape in section with no edge portion on its entire outer surface.

According to the temperature sensor element according to the present invention which is, though, a flat plate type sensor element in which the resistance pattern is formed on the cuboidal insulating substrate, temperature detection can be suppressed from varying due to an attachment angle etc.

### BRIEF DESCRIPTION OF THE DRAWINGS

FIG. 1 is a vertical sectional view of a temperature sensor element according to a first embodiment of the present invention;

FIG. 2 is a horizontal sectional view of the temperature sensor element;

FIG. 3 is a sectional view taken along a line III-III of FIG. 1;

FIG. 4 is a vertical sectional view of a temperature sensor element according to a second embodiment of the present invention; and

FIG. 5 is a sectional view taken along a line V-V of FIG. 1.

### DETAILED DESCRIPTION OF THE INVENTION

A mode for carrying out the present invention will be described with reference to the drawings. As shown in FIGS. 1 to 3, a temperature sensor element 1 according to a first embodiment of the present invention is configured to include: a cuboidal insulating substrate 2; a resistance pattern 3 which is formed on a longitudinally central portion in a main face 2a (front face) of the insulating substrate 2; a pair of internal electrodes 4 which are formed on longitudinally opposite end portions of the main face 2a of the insulating substrate 2 so as to be connected to opposite end portions of the resistance pattern 3; a pair of lead wires 5 which are bonded on the internal electrodes 4 and protrude outward from the insulating substrate 2; a protective film 6 which covers the resistance pattern 3; and a surface glass film 7 which covers the entire main face 2a of the insulating substrate 2 including the lead wires 5 and the protective film 6.

The insulating substrate 2 is a ceramics substrate made of alumina, zirconia, or the like. When a length of the insulating substrate 2 along the longitudinal direction, a width of the insulating substrate 2 along a lateral direction, and a thickness of the insulating substrate 2 are designated by L, W and T respectively, a sectional shape of the insulating substrate 2 taken along the lateral direction is a rectangle having the thickness T shorter than the width W, as shown in FIG. 3.

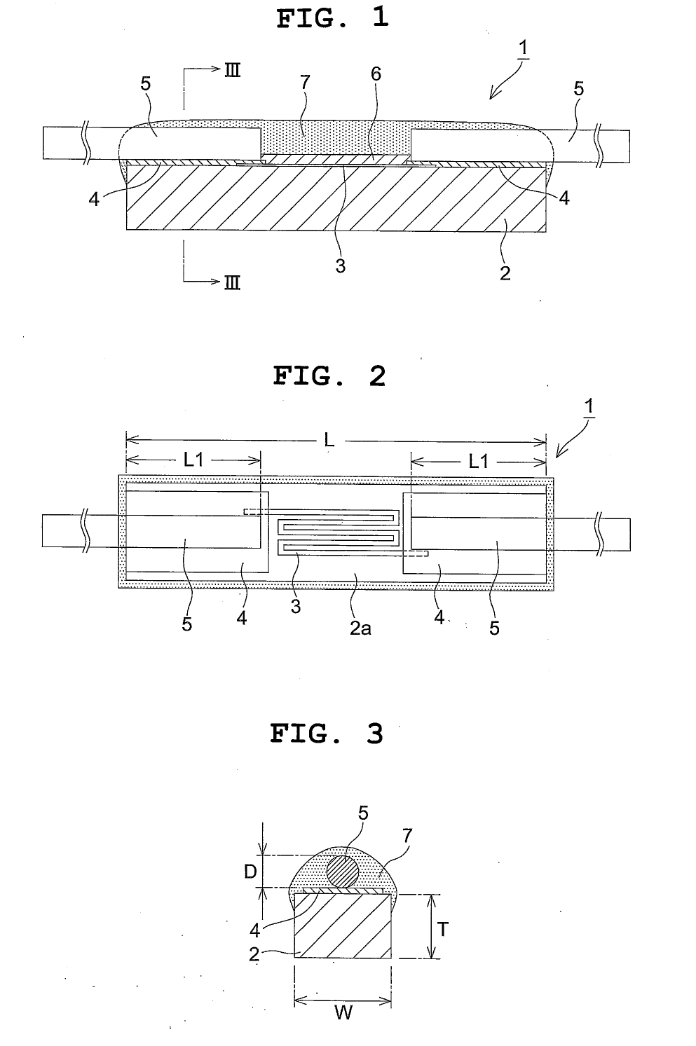

The resistance pattern 3 is a thin resistance film containing platinum as a main component (purity 99.99%). As shown in FIG. 2, the resistance pattern 3 is formed into a meander shape at the central portion of the main face 2a of the insulating substrate 2.

An electrode paste containing platinum (whose content is about 80%) is screen-printed, dried and sintered. Thus, the pair of internal electrodes 4 are obtained. Each of the internal electrodes 4 is a thin-film electrode whose thickness is, for example, 12 μm to 22 μm.

Each of the lead wires 5 paired with each other is, for example, a nickel-core platinum-clad wire. The lead wires 5 are bonded on the internal electrodes 4 correspondingly and respectively by welding. Here, when a wire diameter of each of the lead wires 5 is designated by D, the total dimension (T+D) of the thickness T of the insulating substrate 2 and the wire diameter D of the lead wire 5 is set to be substantially equal to the width W of the insulating substrate 2 along the lateral direction. That is, the thickness T and the width W of the insulating substrate 2 and the wire diameter D of the lead wire 5 are set to satisfy a relation (T+D)≈W. In addition, when a length of a bonding portion between the lead wire 5 and the internal electrode 4 is designated by L1, L1 is at least ⅙ of the length L of the insulating substrate 2. Since the pair of lead wires 5 are bonded to the internal electrodes 4 respectively on the longitudinally opposite end portions of the insulating substrate 2, bonding regions of the pair of lead wires 5 occupy at least ⅓ of the entire length L of the insulating substrate 2.

A glass paste of crystallized glass or the like is screen-printed, dried and sintered. Thus, the protective film 6 is obtained. Although the protective film 6 is not shown in FIG. 2, the protective film 6 is formed on the main face 2a of the insulating substrate 2 so as to cover the whole of the resistance pattern 3.

A glass paste of crystallized glass or the like applied by a dispenser is dried and sintered. Thus, the surface glass film 7 is obtained. The surface glass film 7 is formed to extend over a region which not only covers the entire main face 2a of the insulating substrate 2 including the pair of lead wires 5 and the protective film 6 but also covers respective upper-side faces (two end faces and two side faces) of the insulating substrate 2 adjacent to the main face 2a. Thus, edge portions of four upper sides (two long sides and two short sides) of the insulating substrate 2 surrounding the main face 2a are covered with the surface glass film 7. Accordingly, as shown in FIG. 1, a sectional shape of the surface glass film 7 taken along the longitudinal direction of the insulating substrate 2 is a flat shape which is rounded at its opposite end portions. As shown in FIG. 3, a sectional shape of the surface glass film 7 taken along the lateral direction of the insulating substrate 2 is a triangular shape which is rounded at all its vertices.

Here, each of the internal electrodes 4 interposed between the main face 2a of the insulating substrate 2 and a corresponding one of the lead wires 5 is a thin-film electrode whose thickness is approximately negligible. As described above, the total dimension (T+D) of the thickness T of the insulating substrate 2 and the wire diameter D of each of the lead wires 5 is set to be substantially equal to the width W of the insulating substrate 2 along the lateral direction. Therefore, a thickness-to-width ratio of the sensor element as a whole including the surface glass film 7 is substantially 1:1.

In the temperature sensor element 1 according to the first embodiment, as described above, the resistance pattern 3 which contains platinum as a main component, and the pair of internal electrodes 4 which are connected to the opposite end portions of the resistance pattern 3 are formed on the main face 2a of the insulating substrate 2. The surface glass film 7 is formed to cover the entire main face 2a of the insulating substrate 2 including not only the pair of lead wires 5 which are bonded to the internal electrodes 4 and protrude outward from the insulating substrate 2, but also the protective film 6 which is formed on the resistance pattern 3. At the same time, the surface glass film 7 extends over a region covering the respective upper-side faces of the insulating substrate 2 adjacent to the main face 2a. Accordingly, although the temperature sensor element 1 according to the first embodiment is a flat plate type sensor element in which the resistance pattern 3 is formed on the main face 2a of the cuboidal insulating substrate 2, the outer surface of the surface glass film 7 can be formed as a rounded shape in section with no edge portion. Moreover, the total dimension (T+D) of the thickness T of the insulating substrate 2 and the wire diameter D of each of the lead wires 5 is set to be substantially equal to the width W of the insulating substrate 2 along the lateral direction, and the thickness-to-width ratio of the sensor element as a whole is substantially 1:1. Accordingly, even if an installation angle changes when the sensor element is exposed to an airflow, disturbance is hardly generated in the airflow hitting on the sensor element so that a detection result of the sensor element can be suppressed from varying due to the disturbance of the airflow.

In addition, in the temperature sensor element 1 according to the first embodiment, each of the lead wires 5 is bonded to a corresponding one of the internal electrodes 4 to occupy at least ⅙ of the length L of the insulating substrate 2, and the bonding regions of the pair of lead wires 5 occupy at least ⅓ of the entire length L of the insulating substrate 2. Accordingly, when the glass paste which is the material of the surface glass film 7 is applied by the dispenser, the glass paste can be prevented from being sunk into a concave shape on the protective film 6 formed between the pair of lead wires 5. Thus, the surface glass film 7 having the rounded shape in section can be easily formed all over the insulating substrate 2 in the longitudinal direction.

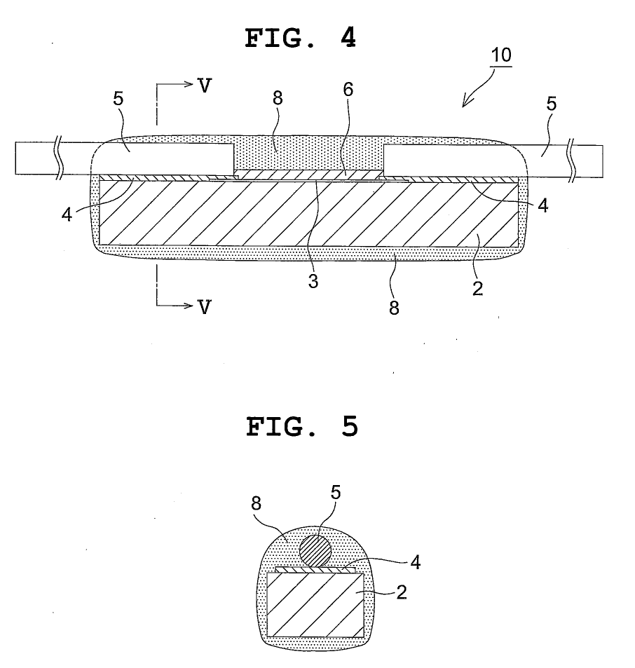

Next, a temperature sensor element 10 according to a second embodiment of the present invention will be described with reference to FIG. 4 and FIG. 5. Incidentally, in FIGS. 4 and 5, corresponding portions to those in FIGS. 1 to 3 are referred to by like signs correspondingly and respectively so that duplicate description thereof will be omitted suitably.

The temperature sensor element 10 according to the second embodiment is different from the temperature sensor element 1 according to the first embodiment in that a surface glass film 8 is formed to cover all faces of an insulating substrate 2 including not only respective upper-side faces of the insulating substrate 2 adjacent to a main face 2a but also a back face of the insulating substrate 2 opposite to the main face 2a. The temperature sensor element 10 according to the second embodiment is fundamentally the same in the remaining configuration as the temperature sensor element 1 according to the first embodiment. That is, the surface glass film 8 covering the entire main face 2a of the insulating substrate 2 is formed to cover not only the main face 2a but also all of the other five faces (two end faces, two side faces and one bottom face) of the insulating substrate 2. Due to such a surface glass layer 8, the temperature sensor element 10 having a rounded shape in section with no edge portion on its entire outer surface can be realized. Incidentally, the surface glass film 8 having such a shape can be formed, for example, by applying a glass paste repeatedly a plurality of times.

Also in the thus configured temperature sensor element 10 according to the second embodiment which is, though, a flat plate type sensor element in which a resistance pattern 3 is formed on the main face 2a of the insulating substrate 2 shaped like a cuboid, the entire outer surface of the surface glass film 8 can be formed as a rounded shape in section with no edge portion. At the same time, a thickness-to-width ratio of the sensor element as a whole is substantially 1:1. Accordingly, even if an installation angle changes when the sensor element is exposed to an airflow, disturbance is hardly generated in the airflow hitting on the sensor element. Thus, it is possible to suppress a detection result of the sensor element from varying due to the disturbance of the airflow.

What is claimed is:

1. A temperature sensor element comprising:
a cuboidal insulating substrate; a resistance pattern which contains platinum as a main component and which is formed on a main face of the insulating substrate; a pair of internal electrodes which are connected to opposite end portions of the resistance pattern; lead wires which are bonded to the pair of internal electrodes respectively and protrude outward from longitudinally opposite end portions of the insulating substrate; a protective film which covers the resistance pattern; and a surface glass film which covers the entire main face of the insulating substrate including the lead wires; wherein:
the surface glass film is formed to cover at least respective upper-side faces of the insulating substrate adjacent to the main face, and when a width of the insulating substrate along a lateral direction, a thickness of the insulating substrate, and a wire diameter of each of the lead wires are designated by W, T and D respectively, W, T and D are set to satisfy a relation (T+D)≈W.

2. A temperature sensor element according to claim 1, wherein:
when a length of the insulating substrate along the longitudinal direction is designated by L, each of the lead wires is bonded to a corresponding one of the internal electrodes to occupy at least ⅙ of the length L.

3. A temperature sensor element according to claim 1, wherein: the surface glass film covers all faces of the insulating substrate including a back face opposite to the main face.
